(19) United States
(12) Patent Application Publication
(10) Pub. No.: US 2026/0353008 A1
(43) Pub. Date: Nov. 5, 2026

(54) HEAT DISSIPATION IN SPEAKERS

(71) Applicant: Sonos, Inc., Goleta, CA (US)

(72) Inventors: Naphur van Apeldoorn, Amsterdam (NL); Timothy Ruben Scheek, Rotterdam (NL); Job Koreman, Delft (NL); Lars Wouterse, Delft (NL)

(21) Appl. No.: 19/486,161

(22) PCT Filed: May 20, 2024
(86) PCT No.: PCT/US2024/030255

§ 371 Date: Nov. 20, 2025

Related U.S. Application Data
(60) Provisional application No. 63/504,998, filed on May 30, 2023.

(51) Int. Cl. H04R 9/02; H04R 9/06

(52) U.S. Cl. CPC H04R 9/022; H04R 9/025; H04R 9/063; H04R 2400/11

(57) ABSTRACT

Constructions and methods to dissipate heat in speakers are discussed. A speaker unit can include a housing defining an internal volume, a duct coupling the internal volume to an outside of the housing, a first audio driver having a first membrane coupled to the internal volume, and a second audio driver having a second membrane coupled to the internal volume. The second membrane is configured to oscillate in opposition to the first audio driver, and is spaced apart from the first audio driver. At least a portion of an internal opening of the duct is positioned between the first membrane and the second membrane.

### CROSS-REFERENCE TO RELATED APPLICATIONS

This application claims priority to U.S. Patent Application No. 63/504,998 filed May 30, 2023, which is herein incorporated by reference in its entirety. Additional incorporations by reference are made throughout the disclosure.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media play back systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1 is a functional block diagram illustrating certain aspects of an example playback device;

FIG. 2 is a 3D view of a portion of a loudspeaker according to an example;

FIG. 3 is an isometric view of a portion of a loudspeaker according to a further example;

FIG. 4 is a 3D view of an example motor comprising a heat sink;

FIG. 5 is a 3D view of a further example motor comprising a heat sink;

FIG. 6 is a partially cutaway view of a portion of a loudspeaker according to an example; and

FIG. 7 is an example method.

### DETAILED DESCRIPTION

### I. Overview

Audio drivers comprise one or more motors coupled to a membrane that, in operation, are configured to move the membrane to generate sound. A typical motor comprises a magnet and a voice coil. A current driven through the voice coil produces a magnetic field that interacts with the magnetic field generated by the magnet, and thereby moves the voice coil with respect to the magnet. The voice coil is coupled to the membrane so that the motion of the voice coil is at least partially transferred to the membrane. When the voice coil is driven by a current corresponding to an audio signal, the resulting motion of the membrane generates audio corresponding to the audio signal.

The current through the voice coil generates heat by resistive heating. This heating can become significant in certain speaker systems, such as those described in patent applications WO 2018/056814 A1 (‘LOUDSPEAKER UNIT WITH MULTIPLE DRIVE UNITS’), WO 2019/086357 A1 (‘LOW PROFILE LOUDSPEAKER DEVICE’), WO 2022/029005 A1 (‘SPEAKER UNIT’), and WO 2022/096560 A1 (‘SPEAKER UNIT WITH A SPEAKER FRAME AND TWO OPPOSING SOUND PRODUCING MEMBRANES’), each of which are incorporated by reference for all purposes. Speaker systems described therein use audio drivers that comprise a distributed plurality of motors to drive the membrane, wherein the plurality of motors are distributed away from a center of the membrane. Because of this, the voice coils may be wrapped thicker and denser than in a conventional audio driver, thus enabling a flatter and generally smaller form-factor. As the available surface area (relative to the amount of heat generated) is reduced, heat dissipation becomes important.

A voice coil's response to an input signal is dependent on its temperature, a phenomenon known as power compression. It is therefore useful to keep a voice coil's temperature within a range in which the voice coil has expected behaviour. At worst, an audio driver may fail completely from an overheated voice coil. This can happen to voice coils made from copper, copper-clad aluminum coils (CCAW) or aluminum at temperatures over 200 °C. Also, above 150 °C, wire insulation can melt, so it may be necessary to specify wire of a higher wire rating or a larger diameter (gauge). Heating can also cause the magnet to become partially demagnetized so that the interaction between the voice coil and the magnet is altered. Controlling the temperature of the voice coils in an audio driver may therefore provide consistent sound quality of a speaker and increase longevity of the audio driver. Embodiments described herein relate to systems and methods for the dissipation of heat generated by audio drivers.

The thermally dependent frequency response of voice coils may also lead to audio driver performance degradation when the audio driver comprises more than one motor. In operation, one motor may become hotter than another, possibly due to the relative locations of the motors within a speaker housing. For example, a motor positioned above another motor may become hotter in operation due to warm air rising within the speaker housing. With the motors at different temperatures they will have different frequency responses and so will drive the membrane differently. This may impact on the sound generated by the membrane. It may therefore also be useful to ensure that when a speaker membrane has at least two voice coils or motors, all the at least two voice coils or motors are configured to operate at substantially the same temperature.

Accordingly, in a first example there is provided an audio driver comprising: (i) a membrane, (ii) first and second motors configured to drive the membrane, and (iii) a thermally conductive component that thermally couples the first and second motors.

The thermally conductive component allows heat to be distributed between the first and second motors. In other words, the heat can be shared or averaged between the first and second motors. This can help to maintain the two motors at substantially the same temperature, so that the frequency response of each of the motors is substantially the same. Averaging out the heat between the motors therefore causes a reduction in the difference in frequency responses between the motors, while at the same time cooling the hotter motor. The result is improved sound quality and audio driver longevity.

“Thermally conductive” as used herein may be understood to refer to a material having a thermal conductivity greater than 0.1 W/mK, which includes most plastics, greater than 0.5 W/mK, which excludes most plastics, or greater than 10 W/mK, which includes mostly metals.

In some examples, the thermally conductive component may comprise a support, such as a transducer frame, on which the first and second motors are mounted. Heat generated by each motor may be transferred to the support, primarily via conduction. In this way, the heat can be distributed between the motors in such a way that the motors operate at substantially the same temperature. Furthermore, this is a modification of a component so that no additional component is required.

More particularly, the first and second motors may comprise a respective magnetic post and the respective voice coil may be arranged to move along the respective magnetic post. The thermally conductive component may then comprise a thermally conductive frame on which the magnetic posts are mounted. This thermally couples the magnetic posts and therefore substantially equalizes the temperature of the magnetic posts and will also contribute to indirectly equalizing the temperature of the voice coils.

Heat generated by the voice coils is transferred to the magnetic posts via a combination of conduction, convection and radiation. Heat from the magnetic posts is then transferred to the thermally conductive frame on which they are mounted, primarily via conduction. The thermally conductive frame may be arranged to dissipate heat externally from a speaker housing which comprises the audio driver. This may be achieved via how the thermally conductive frame is positioned with respect to the speaker housing (e.g. positioned against, or forming, an exterior surface that is not covered when the speaker is in operation). This may also be achieved by thermally coupling the transducer frame to one or more heat dissipating elements, such as heat sinks. The coupling between the heat dissipating elements and the transducer frame may be achieved using an adhesive with good heat conductivity that will not melt at operating temperatures. Such an adhesive may comprise thermally conductive particles. The heat conductivity of the adhesive may be at least 0.1 W/mK, at least 1 W/mK, at least 3 W/mK or at least 5 W/mK. Suitable adhesives include epoxy resin (one or two part), Silicone resin and Polyimide Resin.

In some examples, the thermally conductive component may comprise a suspension coupling the membrane to the first and second motors. This also allows for a thermal coupling between the motors and the membrane so that heat generated by the motors can be at least partially transferred to the membrane (and away from the motors).

The membrane itself may comprise a thermally conductive material so that heat generated by the motors can be dissipated via the membrane. At least one surface of the membrane may be an external surface so this provides another way to dissipate heat externally. Heat generated by the voice coils is transferred to the membrane, via the suspension, and can be dissipated externally by the membrane.

In some examples, the thermally conductive component may comprise, or be coupled to, a heat sink arranged to dissipate heat from the motors. The temperature of the motors can therefore be reduced at the same time as distributing the heat between the motors so that they are generally the same temperature. The heat sink may be a part of the thermally conductive component, such as integrally formed with it, or it may be coupled directly or indirectly, such as via another component or an air gap. An example configuration is the thermally conductive suspension and membrane described above.

According to a second example, there is provided an audio driver comprising: (i) a membrane; (ii) a motor configured to drive the membrane, the motor comprising a voice coil, and (iii) a heat sink thermally coupled to the voice coil and at least partially covering the voice coil.

This may allow heat to be dissipated more efficiently from the voice coil to the surrounding air. The heat sink may have fins or protrusions facing outwardly from the voice coil.

In some examples, the heat sink is attached to the voice coil. This provides more efficient heat dissipation than if an air gap is present, but will increase the effective mass of the voice coil. In other examples, the heat sink may be separated from the voice coil by an air gap. This may be easier to retrofit than a heat sink that contacts the voice coils, because there is no change in effective mass of the voice coil, although this arrangement is less efficient for heat dissipation. Heat dissipation in that case can be increased by reducing the size of the air gap, for example the air gap may be less than 1 mm, less than 0.5 mm or less than 0.25 mm wide at its largest extent.

The motor may be positioned away from a center of the membrane and the heat sink may be arranged to dissipate heat from the voice coil in a direction that is away from the center of the membrane. Audio drivers with motors positioned away from the center of the membrane are discussed in WO 2018/056814 A1, WO 2019/086357 A1, WO 2022/029005 A1, and WO 2022/096560 A1, previously incorporated herein by reference. The heat sink may be more effective in this arrangement due its position towards the edge of the audio driver.

Dissipating heat in a direction away from the center of the driver may reduce the heat transfer to other components of the audio driver. For example, at least some fins of the heat sink may be directed away from the center of the membrane. In some examples, the heat sink dissipate heat externally from the driver housing, such by having fins which extend into an external volume.

In some examples, the heat sink may extend partially around a circumference of the voice coil. This may allow a compact construction for the heat sink. It may also reduce eddy currents in the heat sink. Eddy currents will draw energy from the motor which may affect the frequency response of the motor, and therefore lead to a reduction in sound quality. The heat sink may extend less than about 270°, less than about 225°, less than about 180°, or less than about 135° around the circumference of the voice coil.

The audio driver with a heat sink according to the second example may be combined with the audio driver with a thermally conductive element of the first example. Such a combination may have improved heat dissipation while working to generally equalize the temperature of the motors.

An audio driver as discussed above for the first and second examples may form part of a speaker. In a third example, there is provided a speaker unit comprising: a housing defining an internal volume; a duct coupling the internal volume to an outside of the housing; a first audio driver having a first membrane coupled to the internal volume; and a second audio driver having a second membrane coupled to the internal volume. The second audio driver is configured to oscillate in opposition to the first audio driver, the second membrane spaced from the first audio driver. At least a portion of an internal opening of the duct is positioned between the first membrane and the second membrane.

The duct couples the internal volume of the housing to the outside so that air inside the housing can escape. The movement/oscillation of the second membrane in opposition to the first membrane results in a compressing and decompressing motion that acts as a bellows. For example, the compressing motion of the membranes forces air out from the internal volume and the decompressing motion of the membranes draws in air from the outside. The positioning of the duct opening allows for effective air movement from the internal volume of the speaker due to the bellows action of the membranes.

In addition, at least one voice coil in the first and/or second audio drivers may be arranged such that the air flow generated by the bellows action cools the voice coil. For example, the air flow may act to remove warm air from the internal volume of the speaker or to introduce air at a cooler temperature (such as at the ambient or room temperature) into the internal volume.

An external opening of the duct to the outside of the housing may have an axis which is approximately perpendicular to the first direction, which is a direction in/along which the first audio driver oscillates. This arrangement of the duct allows for efficient air movement via the bellows action.

In some examples, an external opening of the duct may occupy at least half the area of a face of the housing. Such a relatively large duct allows for more efficient heat dissipation. In some examples, the duct is an aperture, or hole, delimited by the housing.

The speaker unit of the third example may use an audio driver with a thermally conductive component (the first example) and/or an audio driver with a heat sink (the second example). Combining at least one of: (i) the thermally conductive component of the first example and (ii) the heat sink of the second example with the duct of the third example may further improve the heat dissipation and/or improve temperature equalization between motors.

In a fourth example, there is provided (i) a housing defining an internal volume and delimiting a duct, the duct coupling the internal volume to an outside of the housing, (ii) a first audio driver having a first membrane coupled to the internal volume and configured to oscillate in a first direction, and (iii) a second audio driver having a second membrane coupled to the internal volume configured to oscillate in the first direction in opposition to the first audio driver, the second membrane spaced from the first audio driver in the first direction, wherein at least a portion of an internal opening of the duct is positioned between the first membrane and the second membrane along the first direction.

According to a fifth example, there is provided a method of cooling a speaker, the method comprising: using a bellows effect of two membranes oscillating in opposition to each other to drive air flow into and out of an internal volume of the speaker, the air flow cooling at least one voice coil of the speaker. The two membranes may be of substantially the same size and arranged back-to-back, perhaps also coaxially.

The examples described herein may provide effective heat dissipating solutions. They may also, additionally or alternatively, provide a more cost effective alternative to installing higher heat grade magnets that are less affected by high temperatures.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

In the Figures, many of the details, dimensions, angles and other features shown are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Example Playback Device(s)

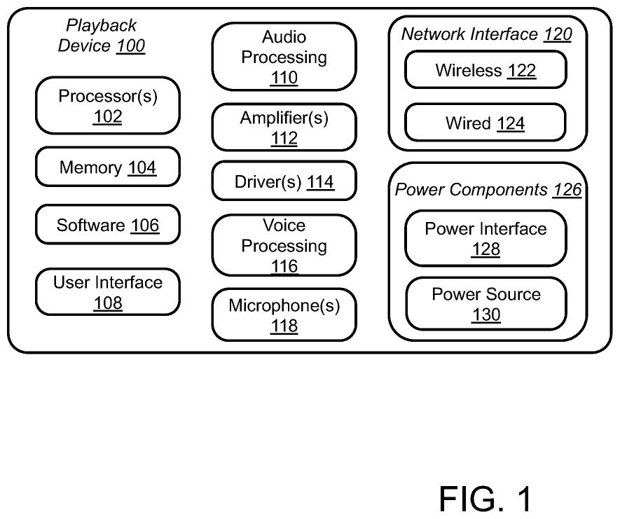

FIG. 1 is a functional block diagram illustrating certain aspects of an example playback device 100. The playback device 100 is configured to output audio via one or more drivers 114 into a playback environment in which the playback device is located (such as a room or outdoors). A driver may be known as an audio driver, a speaker driver and/or a transducer, in some cases. As shown, the playback device 100 includes various components, each of which is discussed in further detail below, and the various components of the play back device 100 may be operably coupled to one another via a system bus, communication network, or some other connection mechanism.

As shown, the playback device 100 includes at least one processor 102, which may be a clock-driven computing component configured to process input data according to instructions stored in memory 104. The memory 104 may be a tangible, non-transitory, computer-readable medium configured to store instructions that are executable by the one or more processors 102. For example, the memory 104 may be data storage that can be loaded with software code 106 that is executable by the one or more processors 102 to achieve certain functions.

In one example, these functions may involve the playback device 100 retrieving audio data from an audio source, which may be another playback device or another device, such as a user device or a remote server. In another example, the functions may involve the playback device 100 sending audio data, detected-sound data (e.g., corresponding to a voice input), and/or other information to another device on a network via at least one network interface 120. In yet another example, the functions may involve the playback device 100 causing one or more other playback devices to synchronously play back audio with the playback device 100. For example, the playback device 100 may be in a group with one or more other playback devices, where devices in the group play back audio in synchrony. In yet a further example, the functions may involve the playback device 100 facilitating being grouped (such as paired or otherwise bonded) with one or more other playback devices to create a multi-channel audio environment. Numerous other example functions are possible, some of which are discussed below.

As just mentioned, certain functions may involve the playback device 100 synchronizing playback of audio content with one or more other playback devices. During synchronous playback, a listener may not perceive time-delay differences between playback of the audio content by the synchronized playback devices. U.S. Pat. No. 8,234,395 filed on Apr. 4, 2004, and titled “System and method for synchronizing operations among a plurality of independently clocked digital data processing devices,” which is hereby incorporated by reference in its entirety, provides in more detail some examples for audio playback synchronization among playback devices.

To facilitate audio playback, the playback device 100 includes audio processing components 110 that are generally configured to process audio prior to the playback device 100 rendering the audio. In this respect, the audio processing components 110 may include one or more digital-to-analog converters (“DAC”), one or more audio preprocessing components, one or more audio enhancement components, one or more digital signal processors (“DSPs”), and so on. In some implementations, one or more of the audio processing components 110 may be a subcomponent of the processor 102. In operation, the audio processing components 110 receive analog and/or digital audio and process and/or otherwise intentionally alter the audio to produce audio signals for play back.

The produced audio signals may then be provided to one or more audio amplifiers 112 for amplification and playback through one or more drivers/transducers 114 operably coupled to the one or more amplifiers 112. The one or more audio amplifiers 112 may include components configured to amplify audio signals to a level for driving one or more of the drivers 114.

A driver 114 may be, for example, a subwoofer (e.g., for low frequencies), a mid-range driver (e.g., for middle frequencies), or a tweeter (e.g., for high frequencies). In some cases, a driver 114 may be driven by an individual corresponding audio amplifier of the one or more audio amplifiers 112.

In addition to producing audio signals for playback by the playback device 100, the audio processing components 110 may be configured to process audio to be sent to one or more other playback devices, via the network interface 120, for playback. In example scenarios, audio content to be processed and/or played back by the playback device 100 may be received from an external source, such as via an audio line-in interface (e.g., an auto-detecting 3.5 mm audio line-in connection) of the playback device 100 (not shown) or via the network interface 120, as described below.

As shown, the at least one network interface 120, may take the form of one or more wireless interfaces 122 and/or one or more wired interfaces 124. A wireless interface may provide network interface functions for the playback device 100 to wirelessly communicate with other devices (e.g., other playback device(s), and/or controller/user device(s)) in accordance with a communication protocol (e.g., any wireless standard including IEEE 802.11a, 802.11b, 802.11g, 802.11n, 802.11ac, 802.15, 4G mobile communication standard, and so on). A wired interface may provide network interface functions for the play back device 100 to communicate over a wired connection with other devices in accordance with a communication protocol (e.g., IEEE 802.3). While the network interface 120 shown in FIG. 1 includes both wired and wireless interfaces, the playback device 100 may in some implementations include only wireless interface(s) or only wired interface(s).

In general, the network interface 120 facilitates data flow between the playback device 100 and one or more other devices on a data network. For instance, the playback device 100 may be configured to receive audio content over the data network from one or more other play back devices, network devices within a LAN, and/or audio content sources over a WAN, such as the Internet. In one example, the audio content and other signals transmitted and received by the playback device 100 may be transmitted in the form of digital packet data comprising an Internet Protocol (IP)-based source address and IP-based destination addresses. In such a case, the network interface 120 may be configured to parse the digital packet data such that the data destined for the playback device 100 is properly received and processed by the playback device 100.

As shown in FIG. 1, the playback device 100 also includes voice processing components 116 that are operably coupled to one or more microphones 118. The microphones 118 are configured to detect sound (i.e., acoustic waves) in the environment of the playback device 100, which is then provided to the voice processing components 116. More specifically, each microphone 118 is configured to detect sound and convert the sound into a digital or analog signal representative of the detected sound, which can then cause the voice processing component 116 to perform various functions based on the detected sound. For example, the play back device 100 may obtain and then play back certain audio content based on a voice input from a user to play that audio content. In another example, the playback device may reconfigure itself based on a voice input from a user. In one implementation, the microphones 118 are arranged as an array of microphones (e.g., an array of six microphones). In some implementations, the playback device 100 includes more than six microphones (e.g., eight microphones or twelve microphones) or fewer than six microphones (e.g., four microphones, two microphones, or a single microphone).

In operation, the voice-processing components 116 are generally configured to detect and process sound received via the microphones 118, identify potential voice input in the detected sound, and extract detected-sound data to enable a Voice Assistant Service (VAS) to process voice input identified in the detected-sound data. The voice processing components 116 may include one or more analog-to-digital converters, an acoustic echo canceller (“AEC”), a spatial processor (e.g., one or more multi-channel Wiener filters, one or more other filters, and/or one or more beam former components), one or more buffers (e.g., one or more circular buffers), one or more wake-word engines, one or more voice extractors, and/or one or more speech processing components (e.g., components configured to recognize a voice of a particular user or a particular set of users associated with a household), among other example voice processing components. In some implementations, one or more of the voice processing components 116 may be a subcomponent of the processor 102.

As further shown in FIG. 1, the playback device 100 also includes power components 126. The power components 126 include at least an external power source interface 128, which may be coupled to a power source (not shown) via a power cable or the like that physically connects the playback device 100 to an electrical outlet or some other external power source. Other power components may include, for example, transformers, converters, and like components configured to format electrical power.

In some implementations, the power components 126 of the play back device 100 may additionally include an internal power source 130 (e.g., one or more batteries) configured to power the playback device 100 without a physical connection to an external power source. When equipped with the internal power source 130, the playback device 100 may operate independent of an external power source. In some such implementations, the external power source interface 128 may be configured to facilitate charging the internal power source 130. A playback device comprising an internal power source may be referred to herein as a “portable playback device.”

The playback device 100 further includes a user interface 108 that may facilitate user interactions independent of or in conjunction with user interactions facilitated by one or more controller/user devices. An example controller device may be, for example, a mobile telephone, a PC, a tablet computer, etc. Controller devices may have installed thereon an application configured to control one or more playback devices in a playback system. In various embodiments, the user interface 108 includes one or more physical buttons and/or supports graphical interfaces provided on touch sensitive screen(s) and/or surface(s), among other possibilities, for a user to directly provide input. The user interface 108 may further include one or more of lights (e.g., LEDs) and the speakers to provide visual and/or audio feedback to a user. Via the user interface 108 and/or a controller device, the user can control various operations of the play back device 100, such as instructing and controlling playback of audio content, and/or configuring the playback device 100.

By way of illustration, SONOS, Inc. presently offers (or has offered) for sale certain playback devices that may implement certain of the embodiments disclosed herein, including a “PLAY:1,” “PLAY:3,” “PLAY:5,” “PLAYBAR,” “CONNECT:AMP,” “PLAYBASE,” “BEAM,” “CONNECT,” and “SUB.” Any other past, present, and/or future playback devices may additionally or alternatively be used to implement the playback devices of example embodiments disclosed herein. Additionally, it should be understood that a playback device is not limited to the example illustrated in FIG. 1 or to the SONOS product offerings. For example, a playback device may include, or otherwise take the form of, a wired or wireless headphone set, which may operate as a part of a playback system via a network interface or the like. In another example, a playback device may include or interact with a docking station for personal mobile media playback devices. In yet another example, a playback device may be integral to another device or component such as a television, a lighting fixture, or some other device for indoor or outdoor use.

It will be appreciated that one or more components illustrated in FIG. 1 are optional, and may be omitted from a playback device. In its simplest form, a playback device 100 comprises one or more processors 102, memory 104 storing instructions, and one or more drivers 114.

### III. Heat Dissipation in Speaker Systems

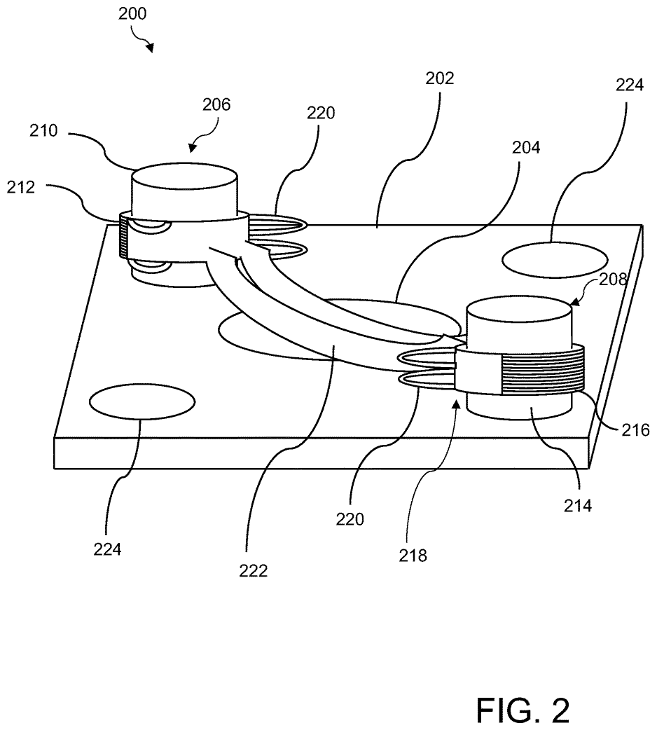

As has been described above, heat is generated by voice coils of an audio driver due to resistive heating as current is passed therethrough. FIGS. 2 to 6 illustrate various audio driver and speaker configurations to provide heat dissipation from voice coils.

### a. Heat Equalization

In some implementations, a thermally conductive component thermally couples the first and second motors to reduce a temperature differential between the motors. FIG. 2 shows part of a transducer, or loudspeaker, 200 comprising a thermally conductive suspension that thermally couples two motors. In some examples, the loudspeaker 200 is at least partially housed in and/or on a playback device, such as playback device 100 shown in FIG. 1.

In the example of FIG. 2, the loudspeaker 200 includes a frame 202 having a membrane 204, or diaphragm, mounted therein. The membrane 204 is resiliently attached and/or flexibly connected to the frame 202. The loudspeaker 200 also includes a first motor 206 and a second motor 208. The first motor 206 includes a first magnetic component 210, also referred to as a magnetic stack or simply a magnet, and a first voice coil 212. The second motor 208 includes a second magnetic component 214 and a second voice coil 216. The first and second magnetic components 210, 214 may be permanent magnets.

The loudspeaker further comprises a suspension system 218. The suspension system 218 comprises first and second suspension elements 220 that respectively couple the first voice coil 212 and the second voice coil 216 to the frame 202. The suspension elements 220 may be referred to as a spider or as a speaker damper. The suspension system 218 further comprises a connecting component 222 that connects the first and second suspension elements 220. The connecting component 222 also connects the first and second suspension elements 220 to the to the membrane 204. In use, a signal is provided to the first and second voice coils 212, 216 causing them to move along their respective central axes. The suspension system 218 moves correspondingly with the voice coils 212, 216. By transmitting movement of the voice coils 212, 216 to the membrane 204, audio may be reproduced by the loudspeaker 200.

The suspension system 220 in FIG. 2, and especially the connecting component 222 is thermally conductive. “Thermally conductive” as used herein describes a material's ability to transfer heat from one portion of the material to another via conduction. Quantitatively, a thermally conductive material may be one that has a thermal conductivity greater than 0.1 W/mK, which includes most plastics, greater than 0.5 W/mK, which excludes most plastics, or greater than 10 W/mK, which includes mostly metals. In FIG. 2, the connecting component 222 is metal, such as Aluminum, and the suspension elements 220 are plastic.

As can be seen from FIG. 2, the suspension elements 220 are in close proximity to the first and second voice coils 212, 216. In practice, the suspension elements 220 may be in contact with the voice coils 212, 216. In either case, the suspension elements 220 are thermally coupled to the voice coils 212, 216 so that heat generated by the voice coils 212, 216 in operation is transferred to the suspension elements 220. Primarily via thermal conduction, heat is then transferred from the suspension elements 220 to the connecting component 222.

Not only is heat transferred away from the voice coils 212, 216, but the thermally conductive suspension system 220 allows for heat from one of the motors to be transferred to the other motor. This has the effect of averaging or equalizing the heat distribution between the motors 206, 208 so that, in operation, the voice coils 212, 216 will be at a similar, or substantially the same, temperature. The frequency response of each of the voice coils will therefore be substantially the same, meaning that the effect of the voice coils 206, 208 on the membrane 204 for a given input signal will be substantially the same and the membrane is driven more uniformly.

The frame 202 further comprises indentations 224 allowing for the addition of two further motors. The two further motors may be similar to the motors 206, 208 discussed above, and may be coupled to a further membrane positioned above the membrane 222 by a further suspension system that is similar to the suspension system 218 described above. As will be discussed in further detail below, the arrangement of motors 206, 208 allow for two membranes to be positioned substantially co-axially and, in operation, to oscillate in opposition to one another. These opposite oscillations act to compress and decompress the air between the opposing membranes. A duct delimited in a housing comprising the audio drivers may allow warm air to be expelled from the housing when the membranes compress towards each other and to draw in cooler air when the membranes depress away from each other. This bellows-type action will be described in further detail below, but it can be understood that when combined with the thermally conductive suspension system 218, heat can be dissipated from the voice coils and transferred externally from the housing.

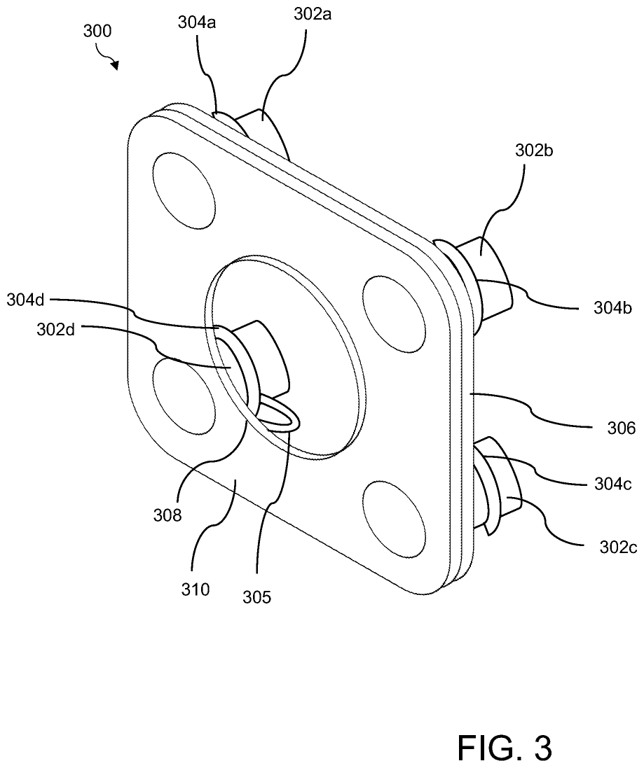

FIG. 3 illustrates part of a loudspeaker system 300, with a housing removed so the construction inside can be understood. The loudspeaker 300 comprises four motors comprising respective magnetic components 302a-d and voice coils 304a-d.

The loudspeaker 300 further comprises a frame 306, also referred to as a transducer frame, connected to the magnetic components 302a-d and delimiting an aperture 308 in which a membrane can be positioned in operation. The plurality of motors comprises two pairs of motors that are each configured to drive a respective membrane. In this way, membranes of the loudspeaker 300 may operate according to a bellows-type action to generate sound, as has briefly been described above.

The frame 306 provides a support on which the magnetic components 302a-d are mounted. A suspension system 305 may be implemented to couple the voice coils 304a-d to the frame 306 and to the membranes. Such a suspension system may be similar to the suspension system 218 described with respect to FIG. 2, and therefore comprised of a thermally conductive material so as to distribute generated heat between each pair of voice coils. The membrane may also be made from a thermally conductive material, such as a metal or metal alloy, to provide more effective heat dissipation from the interior of the loudspeaker 300 to the environment.

The frame 306 itself may be comprised of a thermally conductive material. This allows heat generated by the voice coils 304a-d to be transferred to the magnetic components 302a-d, and then from the magnetic components 302a-d to the frame 306. As the frame 306 is in contact with each of the magnetic components 302a-d, it thermally couples each magnetic component 302a-d to one another allowing heat to be evenly distributed between the magnetic components 302a-d, and therefore between the voice coils 304a-d. This may cause the voice coils 304a-d to operate at similar, or substantially the same, temperatures, resulting in substantially the same frequency responses and therefore improved sound quality.

The loudspeaker 300 further comprises a thermally conductive component 310, also referred to as a heat dissipating component. The thermally conductive component 310 is thermally coupled to the frame 306. The thermal coupling in the loudspeaker 300 is achieved by physically attaching the thermally conductive component 310 to the frame 306, possibly via the use of a thermally conductive adhesive. However, in other examples, the thermal coupling may be achieved by integrally forming the thermally conductive component 310 with the frame 306, or physically coupling directly or indirectly the thermally conductive component 310 to the frame 306, such as via another component or an air gap.

The thermally conductive component 310 may form an exterior surface of a speaker system in which the loudspeaker 300 is implemented or may be further coupled to an exterior surface of such a speaker system, so that heat generated by the motors can be dissipated externally from the loudspeaker 300. In this example, not only is the heat approximately evenly distributed between the voice coils 304a-d, but heat is dissipated externally, lowering the overall temperature of the voice coils 304a-d. This may allow the voice coils 304a-d to be wrapped more densely around the magnetic components 302a-d without substantially affecting the frequency response of the voice coils 304a-d, resulting in a speaker having a smaller form-factor.

### b. Heat Dissipation by Heat Sinks

In some embodiments, a heat sink may be thermally coupled to at least one of the voice coils of an audio driver and may at least partially cover the at least one voice coil. This allows for more direct heat dissipation from the voice coils, which are typically the primary source of heat generation in an audio driver.

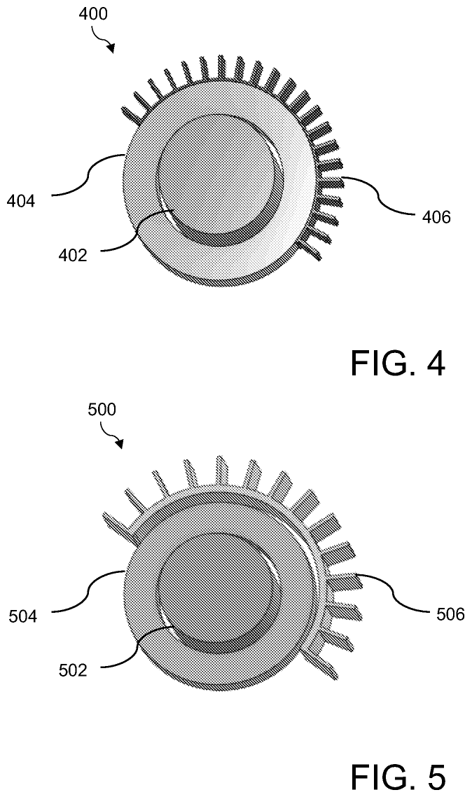

FIG. 4 shows a top down 3D view of a motor 400 comprising a magnetic component 402 (e.g. a permanent magnet) and a voice coil 404 arranged to move longitudinally along the length of the (cylindrical) magnetic component 402 in operation. A heat sink 406, comprising a plurality of fins, is attached, or in contact with, the voice coil 404. The heat sink 406 may also be referred to as a sheath due to its close-fitting design around the voice coil 404.

This arrangement of the heat sink 406 provides effective heat dissipation from the voice coil 402 because the heat transfer is achieved by conduction. As shown, the heat sink 406 extends partially around a circumference of the voice coil 404. Not only does this allow for a compact construction for the heat sink 406, but it can reduce eddy currents in the heat sink 406, which can draw energy from the motor and may affect the frequency response of the motor, and reduce sound quality.

The heat sink 406 extending partially around a circumference of the voice coil 404 further allows for directional heat dissipation; in other words, heat will be dissipated in a direction corresponding to the positioning of the heat sink 406 on the voice coil 404. When implemented in a loudspeaker, such as loudspeakers 200, 300 discussed with respect to FIGS. 2 and 3, the motor 400 can be arranged such that heat is dissipated in a direction away from a center of a membrane, which is typically a center of a loudspeaker system.

The heat sink 406 may be integrated into a structure that couples the membrane and/or ribs to the voice coil 404. In this way, the heat sink 406 may be provided as a separate component from the voice coil 404 rather than as a composite component. In other examples, the heat sink 406 may be fixedly attached to the voice coil 404.

The coupling of the heat sink 406 to the voice coil 404 may be difficult because the external surface of a voice coil 404 may not be sufficiently uniform for consistent attachment between the heat sink 406 and the voice coil 404. To overcome such challenges, the voice coil 404 may use wire profiles that present a flatter external surface for the heat sink 406, or a profile of the heat sink 406 may be matched to the profile of the voice coil 404 to improve attachment.

A further challenge for the arrangement of the heat sink 406 is that the attached heat sink 406 adds mass to the voice coil-heat sink system, changing the effective response of the voice coil 404 to a given input signal. Other parts of the loudspeaker design may need to be adjusted to compensate for the effect of the increased effective mass of the voice coil 404, so that the loudspeaker has expected behaviour within its operational limits, and therefore generates sound as intended. This could be achieved, for example, by reducing the size or gauge of the voice coil wire to reduce overall weight, or by adjusting the magnetization of the magnetic component, amongst other adjustments known to the skilled person.

In another example, a heat sink may be thermally coupled to a voice coil in such a way that the heat sink is separated from the voice coil by an air gap. Such an example is shown in FIG. 5, which shows a similar top down 3D view of a motor 500 as FIG. 4. The motor 500 comprises a magnetic component 502 and a voice coil 504 surrounding it. The motor 500 further comprises a heat sink 506 separated from the voice coil 504 by an air gap so that heat transfer from the voice coil to the heat sink occurs via conduction through the air gap, radiation and convection, rather than primarily by conduction at a point of contact between the voice coil and the heat sink as in the motor 400 shown in FIG. 4.

The arrangement of the heat sink 506 shown in FIG. 5 avoids the attachment difficulties and increased effective mass of the voice coil present in the arrangement of the heat sink 406 shown in FIG. 4, but may be less efficient for heat dissipation, and may require some additional space around the motor inside a speaker enclosure due to the slightly larger construction of the heat sink 506 compared with the heat sink 406.

Heat dissipation efficiency may be increased by reducing the size of the air gap between the voice coil 504 and the heat sink 506. The size of the air gap, for example, may be less than 1 mm, less than 0.5 mm or less than 0.25 mm wide at its largest extent.

Again, when implemented as part of a loudspeaker, the motor 500 may be positioned such that the fins are generally directed away from (or at least not towards) a center axis of the membrane so that heat is dissipated away from the center of the audio driver, and towards the exterior of the loudspeaker.

While the heat sinks 406, 506 are shown as extending approximately 180 degrees around the circumference of the voice coil, it is understood that such a heat sink could extend to a greater or lesser extent around the circumference of the voice coil. For example, the heat sink may extend less than about 270 degrees, less than about 225 degrees, less than about 180 degrees, or less than about 135 degrees around the circumference of the voice coil. In some examples, the heat sink may completely surround the voice coil.

Heat sinks coupled to the voice coils as described above may be implemented in any of the audio drivers discussed herein. For example, such heat sinks may be implemented in an audio driver comprising a thermally conductive component arranged to evenly distribute the heat between two or more motors as has been described above. The combined effect of the heat sinks and thermally conductive component may provide more effective heat dissipation from the voice coils, while at the same time as maintaining the voice coils at substantially the same temperature.

### c. Speaker Housing with Ducts

Further opportunities for heat dissipation arise when an audio driver comprising opposed membranes is implemented in a loudspeaker. As previously mentioned, speaker including two membranes that move in opposition are described in WO 2018/056814 A1, WO 2019/086357 A1, WO 2022/029005 A1, and WO 2022/096560 A1, previously incorporated herein by reference. The movement/oscillation of a second membrane in opposition to a first membrane results in a compressing and decompressing motion, compressing air situated within a volume enclosed between the opposing membranes when they move towards each other, and decompressing air in this enclosed volume when the opposing membranes draw apart from each other. This can be used to provide a bellows effect that may assist cooling.

In embodiments, the housing delimits a duct, aperture, hole, opening or vent coupling the internal volume of the housing to an exterior of the housing (such as into the environment surrounding the loudspeaker). At least a portion of an internal opening of the duct may be positioned between the first membrane and the second membrane. The internal opening of the duct may have an axis which is generally perpendicular to a direction of oscillation 610 of the membranes. In this way, the membranes and duct act similarly to a bellows, wherein the compressing motion of the membranes forces (hot) air out from the internal volume and the decompressing motion of the membranes draws in (cold) air from the outside.

This may provide an effective way to remove heat from the internal volume of the loudspeaker, and which is generated by the action of the voice coils to generate audio. The alignment of the duct opening allows for effective air movement from the internal volume of the speaker due to the bellows action of the membrane.

The addition of the duct in the housing will affect the acoustic properties of the loudspeaker, and other parts and/or dimensions of the loudspeaker may need to be adjusted to compensate for this.

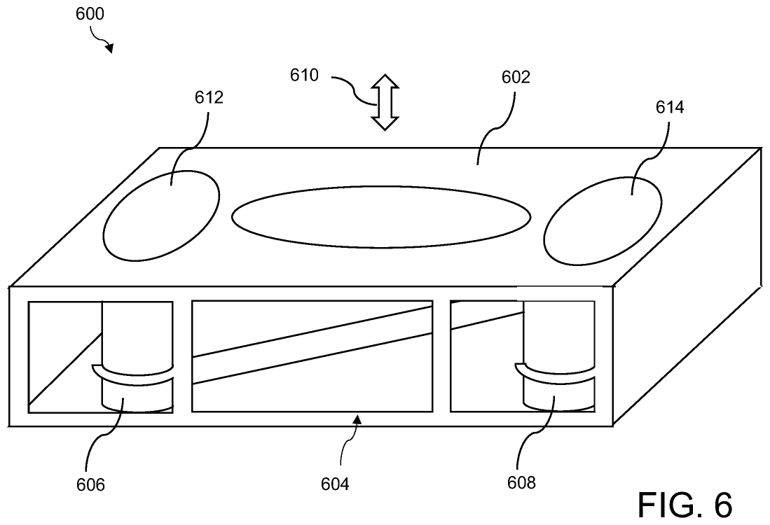

FIG. 6 shows a perspective cutaway view of part of a further example loudspeaker 600. The loudspeaker 600 comprises a housing 602 defining an internal volume. The loudspeaker further comprises a first motor 606 and a second motor 608 configured to drive respective membranes, causing them to oscillate in a first direction 610. The housing 602 delimits three ducts 604 along an exterior surface of the housing 602 that is perpendicular to the direction of oscillation of the membranes. The geometry of the motors and membranes allows the ducts to occupy most of the face of the housing 602 delimiting the ducts 604. Such large ducts 604 allow for more efficient heat dissipation from the internal volume of the housing 602. The ducts 604 shown in FIG. 6 are relatively short, and it is understood that longer ducts are also possible.

The external opening of the ducts 604 may form an aperture in the speaker unit into which the loudspeaker 600 is implemented so that one side of the speaker unit is essentially open. In another example, the external opening of the ducts 604 may be positioned against an exterior surface of the speaker unit, but still allowing for thermal coupling of the internal volume to the exterior of the speaker unit.

The ducts 604 with respect to the motors 606, 608 may also be arranged such that the air flow generated by the bellows action of the membranes cools the motors 606, 608. For example, the air flow may remove warm air from the internal volume of the loudspeaker 600 as well as lower the temperature of the motors 606, 608 by increasing the rate of convection in the air surrounding the voice coil when cool air is drawn into the housing 602, in a similar manner to heat loss via wind chill.

In some examples, a loudspeaker may comprise at least one channel, or passage, arranged to direct air over the motors. As the membranes compress and decompress the air inside the loudspeaker, air is forced through the channel(s) and over the motors, providing a cooling effect.

The loudspeaker 600 further comprises a first thermally conductive component 612, here comprised of aluminum, and coupling the first motor 606 to another motor positioned adjacent to the first motor 606, but hidden from view in FIG. 6. The loudspeaker 600 further comprises a second thermally conductive component 614, also comprised of aluminum, and coupling the second motor 608 to another motor positioned adjacent to the second motor 608, also hidden from view in FIG. 6.

The first and second thermally conductive components 612, 614 are arranged to equalize heat between motors so that they operate at substantially the same temperature, as has been described above. The thermally conductive components 612, 614 may also function as a heat sink to dissipate additional heat.

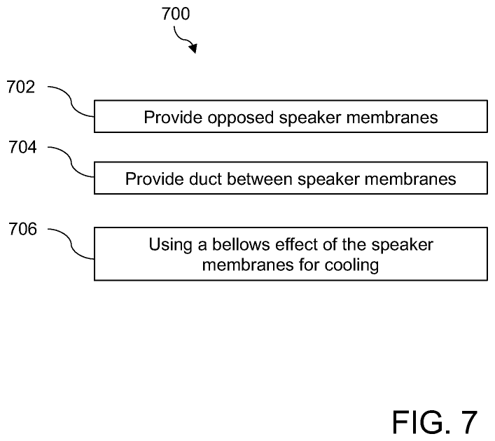

FIG. 7 shows an example method 700 of cooling a speaker, such as the loudspeaker 600 shown in FIG. 6. At block 702, a speaker is provided with opposed speaker membranes. For examples, the speaker may comprise two membranes configured to oscillate in opposition to generate sound, as has been described above. The two membranes may be of substantially the same size and/or arranged back-to-back and/or coaxially. Other configurations are possible, for example the opposed membranes may be offset and/or not of the same size.

At block 704, a duct is provided with an opening between the opposed speaker membranes. For example, a housing of the speaker may delimit one or more ducts coupling the internal volume of the housing to an exterior of the housing. In other examples, the duct may be a part of a support structure for the speaker membranes, such as a discrete component attached, directly or indirectly, to the support structure. The duct may also be an integral part of the support structure, such as formed by molding or additive manufacture of the support structure.

At block 706, the method 700 comprises using a bellows effect of the speaker membranes for cooling. The bellows effect may be generated by the two membranes oscillating in opposition to each other to drive air flow into and out of an internal volume of the speaker, via the duct(s). This can act to expel warmer air from the internal volume, providing a cooling effect. In some examples, the duct may be configured to direct the flow of air over the voice coils, providing additional cooling of those components.

### IV. Conclusion

The present disclosure discussed various examples by which the thermal performance of a speaker can be improved. The skilled person understands that while the examples discussed above may consider a single way of improving thermal performance, these can be combined in other examples.

For example, the combination of a duct in the housing of a speaker with a thermally conductive component arranged to equalize the heat between two or more motors and/or heat sinks coupled to the voice coils may provide particularly effective heat dissipation. For example, heat may be dissipated from the voice coils via heat sinks into the air residing in the internal volume of the housing and then evacuated more efficient via a bellows motion of opposed membrane. Similarly, the thermally conductive component may act to dissipate some heat from the motors while also maintaining the motors at substantially the same temperature. Some of this heat may be dissipated externally by a thermally conductive membrane and/or a thermally conductive support on which the motors are mounted.

Patent applications WO 2018/056814 A1, WO 2019/086357 A1, WO 2022/029005 A1, and WO 2022/096560 A1, describe examples of loudspeaker units with which the heat dissipating means described herein may be used. Other forms of loudspeaker may also be used with the techniques described herein.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. An audio driver comprising:
a membrane;
first and second motors configured to drive the membrane; and
a thermally conductive component that thermally couples the first and second motors.

2. The audio driver according to claim 1, wherein the thermally conductive component comprises, or is coupled to, a heat sink arranged to dissipate heat from the motors.

3. The audio driver according to claim 1, wherein:
the thermally conductive component comprises a support on which the first and second motors are mounted.

4. The audio driver according to claim 1, wherein:
the thermally conductive component comprises a suspension coupling the membrane to the first and second motors.

5. The audio driver according to claim 4, wherein the membrane comprises a thermally conductive material.

6. An audio driver comprising:
a membrane;
a motor configured to drive the membrane, the motor comprising a voice coil; and
a heat sink thermally coupled to the voice coil and at least partially covering the voice coil

7. The audio driver according to claim 6, wherein the heat sink is attached to the voice coil.

8. The audio driver according to claim 6, wherein the heat sink is separated from the voice coil by an air gap.

9. The audio driver according to claim 6, wherein the motor is positioned away from a center of the membrane and the heat sink is arranged to dissipate heat from the voice coil in a direction that is away from the center of the membrane.

10. The audio driver according to claim 6, wherein the heat sink extends partially around a circumference of the voice coil.

11. The audio driver according to claim 10, wherein the heat sink extends less than about 270 degrees around the circumference of the voice coil.

12. A speaker comprising an audio driver according to claim 1.

13. A speaker unit comprising:
a housing defining an internal volume;
a duct coupling the internal volume to an outside of the housing;
a first audio driver having a first membrane coupled to the internal volume; and
a second audio driver having a second membrane coupled to the internal volume and configured to oscillate in opposition to the first audio driver, the second membrane spaced from the first audio driver,
wherein at least a portion of an internal opening of the duct is positioned between the first membrane and the second membrane.

14. The speaker unit according to claim 13, wherein an external opening of the duct to the outside of the housing has an axis which is approximately perpendicular to a first direction, wherein the first direction is a direction along which the first audio driver oscillates.

15. The speaker unit according to claim 14, wherein an external opening of the duct occupies at least half the area of a face of the housing.

16. The speaker unit according to claim 13, wherein the duct is an aperture delimited by the housing.

17. (canceled)

18. A speaker comprising an audio driver according to claim 6.
